(19) United States
(12) Patent Application Publication
(10) Pub. No.: US 2024/0420082 A1
(43) Pub. Date: Dec. 19, 2024

(54) System and Method for Collaborative Book Creation

(71) Applicant: Scriptive LLC, Dodgeville, WI (US)

(72) Inventors: Robert Lee Wood, Dodgeville, WI (US); Debra Ann Wood, Dodgeville, WI (US); Jesse Hyrum Wood, Dodgeville, WI (US)

(21) Appl. No.: 18/742,277

(22) Filed: Jun. 13, 2024

Related U.S. Application Data
(60) Provisional application No. 63/472,677, filed on Jun. 13, 2023.

(51) Int. Cl. G06Q 10/101

(52) U.S. Cl. CPC G06Q 10/101

(57) ABSTRACT

A method for creating a story includes providing a platform that is accessible to more than one user; inputting a collection into the platform by a first user, wherein the collection comprises text, illustrations, or a combination thereof; storing the collection within the platform; and producing an initial specimen comprising a specimen text, a specimen illustration, or a combination thereof, wherein the specimen text is selected from the collected text of the collection and the specimen illustration is selected from the collected illustrations of the collection.

### CROSS REFERENCE TO A RELATED APPLICATION

This application claims the benefit of provisional patent application U.S. App. No. 63/472,677, filed on Jun. 13, 2023 and entitled “SYSTEM AND METHOD FOR COLLABORATIVE BOOK CREATION”, the entire contents of which are hereby expressly incorporated by reference into the present application.

### BACKGROUND OF THE INVENTION

### 1. Field of the Invention

The invention relates to a system and method that allows multiple users to collaborate to create new and/or modified stories based on preexisting text, illustrations, and the like.

### 2. Discussion of the Related Art

Learning through stories, books, and art is a cornerstone of education-especially education of elementary level children. While there are many illustrated children's books, those are purely the books that survived the limiting process and pathway to publication. While not the exclusive method, traditional publishing processes necessitate multiple gatekeeping steps that rely on the publisher's viewpoint in order to be chosen for publication.

Alternatively, although avoiding the selective processes of publishing in a publishing house, self-publishing requires the writer to oversee every possible detail of writing, illustration, editing, and marketing. It is a select group that has success when self-publishing their work.

In effect, children are likely only able to obtain books that someone believed those children would enjoy and use to enhance their learning.

Moreover, writing and illustrating a book is often a singular or small group endeavor that results in only one finished product with no ability to modify that book after publication. While those methods to create children's books can be effective, with each unique story or illustration idea, there is untapped creative potential that offers the opportunity to create or collaborate beyond the previous boundaries of story or children's book creation.

Further, writing and illustrating narratives provide crucial benefits to elementary-age children, such as developing creative thinking, decision-making skills, and language development. It would be advantageous for children, parents or educators to be able to select from an open group of books to pick which book, narratives, and or illustrations they prefer for a specific application. A need therefore exists for an open method of story creation driven by collaboration and available text and illustrations.

### SUMMARY OF THE INVENTION

The disclosed invention addresses the above-identified issues and improves upon the prior art by providing a system for story creation comprising a collection comprising text, illustrations, or a combination thereof; a platform that is accessible to more than one user and provides a medium to (i) input the collection into the platform, wherein a first user inputs the collection, (ii) store the collection, and (iii) enable a second user to produce a specimen comprising a select text, a select illustration, or a combination thereof. The selected text is selected from the text of the collection and the selected illustration is selected from the illustrations of the collection.

The disclosed invention further provides a method for creating a story comprising providing a platform that is accessible to more than one user; inputting a collection into the platform by a first user, wherein the collection comprises text, illustrations, or a combination thereof; storing the collection within the platform; and producing an initial specimen comprising a specimen text, a specimen illustration, or a combination thereof, wherein the specimen text is selected from the collected text of the collection and the specimen illustration is selected from the collected illustrations of the collection. The initial specimen is modified, thereby creating a modified specimen.

The disclosed invention still further provides a system for collaborative story creation comprising: a collection comprising collected text, collected illustrations, or a combination thereof; a platform comprising a collection database that stores the collection; an initial specimen, the initial specimen comprising a specimen text, a specimen illustration, or a combination thereof, wherein the specimen text is selected from the collected text of the collection and the specimen illustration is selected from the collected illustration; and a modifying medium for more than one user to modify the initial specimen to create a modified specimen.

Additional features, advantages and aspects of the present invention will be made apparent from the following description taken together with the drawings.

### BRIEF DESCRIPTION OF THE DRAWINGS

Preferred exemplary embodiments of the invention are illustrated in the accompanying drawings in which like reference numerals represent like parts throughout, and in which:

FIG. 1 is a diagram illustrating a first representative application of the system and method for collaborative story creation in accordance with the present invention;

FIG. 2 is a diagram illustrating a second representative application of the system and method for collaborative story creation in accordance with the present invention;

FIG. 3 is a diagram illustrating a third representative application of the system and method for collaborative story creation in accordance with the present invention; and

FIG. 4 is a diagram illustrating a fourth representative application of the system and method for collaborative story creation in accordance with the present invention.

In describing the embodiments of the invention that are illustrated in the drawings and following specification, specific terminology will be resorted to for the sake of clarity. However, it is not intended that the invention be limited to the specific terms so selected, and it is to be understood that each specific term includes all technical equivalents, which operate in a similar manner to accomplish a similar purpose.

### DETAILED DESCRIPTION

The present invention and the various features and advantageous details thereof are explained more fully with reference to the non-limiting embodiments described in detail in the following description.

The present invention provides a system and a method for collaborative story creation. In one exemplary embodiment, a collection of text, illustrations, and the like are input into a platform that is accessible to multiple users. The platform provides a medium to store the collection and produce an initial specimen of select text and/or select illustrations pulled from the collection. The platform may also provide a medium for the multiple users to modify/edit the initial specimen, creating a modified specimen. Other users may then be able to further modify the modified specimen via the platform.

The system for collaboratively creating stories includes a platform. The platform is accessible to multiple (i.e., more than one) users. A user may constitute any person, machine, software, or the like that accesses and/or uses the platform in any way. Users perform a variety of different functions through the platform (“platform functions”). In other words, the platform provides a medium to perform platform functions. The platform functions accessible to a user may include at least one of, some of, or all of the following: (i) input a collection of text, illustrations, or combination thereof into the platform; (ii) store a collection of text, illustrations, or combination thereof within the platform; (iii) produce an initial specimen of select text, select illustrations, or a combination thereof; (iv) modify an initial specimen to create a modified specimen; (v) further modify a modified specimen to create a further modified specimen; (vi) view and/or purchase at least a part of a collection, an initial specimen, a modified specimen, or a further modified specimen; and (vii) rank one or more of a collection, an initial specimen, a modified specimen, or a further modified specimen.

More than one user may have access to the platform and the platform functions. By providing more than one user access to the platform, the system allows users to collaborate. Access to the platform means a user has the ability to perform at least one platform function via the platform. A user may have the ability to perform only one platform function, multiple platform functions, or all platform functions. Different users may have different access to different platform functions.

In one embodiment, the platform is a computer operating system that includes both hardware and software. The hardware and software are specifically adapted for users to perform platform functions through the computer operating system. For example, the hardware may house the software and provide the requisite data storage to store the electronic data and/or files containing multiple collections and various specimens. The software acting by means of the hardware provides users an interface to input a collection and interact with various specimens.

A user inputs a collection of text, illustrations, or a combination thereof into the platform. A collection may contain either multiple separate items of text and/or illustrations or a single piece of text and/or illustration. In one embodiment, the text and/or illustrations of a collection may be grouped together to form a story/narrative or have a common theme. In another embodiment, the text and/or illustrations of a collection are unrelated to each other. Once the collection is input into the platform, at least a part of the collection is accessible to other users of the system. Thus, other users receive the benefit of the collection.

The user that inputs a collection into the platform may have sufficient rights to the collection to distribute and/or modify the collection. By inputting a collection into the platform, a user may grant other users the right to view and/or modify material from the collection. In one embodiment, the user inputting the collection may be a publisher and the collection may be an illustrated book, such as but not limited to a children's book. A publisher may be any or entity that has the right to disseminate text, illustrations, or a combination thereof, including publishing houses and self-publishers. Typically, a publisher will own all rights and title to a multitude of collections of text and/or illustrations. In such an embodiment, a publisher owns all rights and title to the material within a collection. The publisher inputs the collection into the platform, granting other users the right to view the collection material. The collection may contain previously published material or unpublished material. In another embodiment, a collection contains unpublished material that, for example, was deemed unworthy of publishing. In this case, other users receive the benefit of the collection material that would have otherwise been unused by the publisher.

The platform of the inventive system provides a medium for inputting a collection into the platform. In one embodiment, the collection is contained in an electronic file. A user may input the collection into the platform by uploading the electronic file to the platform. For example, the platform may provide a unique interface that allows a user to upload an electronic file containing a collection.

The platform also provides a medium to store one or more collections. The platform may provide a medium to store an electronic file that contains the collection. In one embodiment, the platform itself stores the collection. In another embodiment, the collection is stored outside of the platform, and the platform provides a means to access the stored collection. Once stored, the text and/or illustrations of a collection are accessible to at least one or more users of the system. Collections may be stored within databases. The databases may be searchable and organized based on specific criteria. For example, multiple collections may be stored within a single database and organized by genre, theme, type of material (e.g., text or illustrations), inputting user/publisher, general age compatibility of material, user rankings, etc. The material within collections themselves may also be organized within sub-databases. For example, a text sub-database may store all the text of a collection, and an illustration sub-database may store all the illustrations of a collection.

Another platform function of the present system includes producing an initial specimen. An initial specimen includes text, illustrations, or a combination thereof selected from the collection. The text and illustrations contained in an initial specimen shall be referred to as select text and select illustrations, respectively. The selected text and selected illustrations may be chosen from a single collection or from multiple collections. In one embodiment, the select text and select illustrations are related, e.g. falling under the same theme or combined to create a narrative. In another embodiment, the initial specimen may only contain one of select text or select illustrations. In other words, in this embodiment the initial specimen is void of either text or illustrations.

In one embodiment of the inventive system, an initial specimen is produced by a user selecting text and/or illustrations from one or more of the stored collections. In this embodiment, a user has access to the stored collections and may view text and/or illustrations of the collections. A user views the available material within a collection and picks select text and/or select illustrations to form an initial specimen. The collection or collections may be organized into searchable databases, to which the user has access. For example, the user may search for a particular theme within a collection database and pick text and/or illustrations to form an initial specimen aligning with the theme. In a representative example, the user may be an educator selecting text and/or illustrations for a classroom exercise.

In another embodiment, an initial specimen is automatically produced without a user's input. The platform may provide an automated means to pick text and/or illustrations from a collection. In one embodiment, a group of text and illustrations within a collection may be taken directly from the collection as-is to produce an initial specimen. In another embodiment, an operating system produces templates containing select text and/or select illustrations that were previously picked and programmed into the operating system. In yet another embodiment, the platform is capable of distinguishing between the text and illustrations within a collection. By distinguishing between text and illustrations, the platform may automatically remove one of the text or illustrations such that the initial specimen is void of either select text or select illustrations

The platform may also provide a medium to modify the initial specimen to create a modified specimen. A modified specimen is created once a user modifies an initial specimen in any way. For example, a user may add color to a previously color-less initial specimen, add text to an initial specimen only containing an illustration, or add an illustration to an initial specimen only containing text. Modification may include a user adding to or deleting from the initial specimen.

The modified specimen may include newly created material supplied by a user that had not previously existed. For example, a user may draw a new illustration or write a new narrative that is added to an initial specimen. A user may also modify an initial specimen by adding preexisting text and/or illustrations to an initial specimen. The preexisting text and/or illustrations may be selected from the collection. For example, a user may add an existing illustration from a collection to an initial specimen.

In one embodiment, a user modifies the initial specimen through the platform itself. For example, the platform may provide an interface that allows a user to view and modify an initial specimen. When the platform is a computer operating system, a user may interact with the operating system via traditional means (e.g., keyboard, mouse, touchscreen) to modify the initial specimen through an interface. In another embodiment, the initial specimen is modified outside the platform. For example, the platform may provide a means to download or print an initial specimen. Once the initial specimen is outside the platform, a user may modify the initial specimen via any other means (e.g., modifying a hard-copy or through a separate editing operating system). The platform may then provide a means to upload the modified specimen to the platform.

The platform may allow multiple users to modify initial specimens. Thus, a second user—i.e., a user different from the first user that inputs the collection into the platform—may have the ability to modify the initial specimen, rather than only the first user having the ability to modify the collection. By allowing multiple users a medium to modify initial specimens, the present system grants more than one user the ability to modify the text and/or illustrations within the collection. Thus, a wide number of users may share the benefit of the initial specimens, and subsequently the text and/or illustrations within a collection, as opposed to a collection being restricted to the single person who owns the collection.

Additionally, the platform may provide a medium to further modify a modified specimen to create a further modified specimen. After a user creates a modified specimen, other users may have the ability to view and even further modify the modified specimen. Thus, a third user—i.e., a user different from the first user that inputs the collection and the second user that modifies the initial specimen—may further modify the already altered modified specimen by adding or deleting text and/or illustrations. Multiple users may further modify a modified specimen. Such further modification may be performed via the same means as the initial modification. By allowing multiple users to modify a modified specimen, the present system provides a means for multiple users to collaborate to produce a single combination of text and or illustrations. In other words, multiple users may contribute to a single piece of work. Thus, in one embodiment, multiple users may collaborate to create a story or a narrative.

Additionally, the platform may include a means to store all the initial specimens, modified specimens, and further modified specimens (collectively, the “available specimen”). Similar to the storage of the collections, the available specimen may be stored within the platform itself or outside of the platform. Further, the available specimen may be stored within organized databases and sub-databases. The databases may be organized via a variety of different criteria or characteristics, such as type of available specimen (e.g., initial or modified), the type of material within an available specimen (e.g., text or illustrations), or the content within the available specimen (e.g., theme of available specimen). The platform may provide a user the medium to search the available specimen databases to find a particular type of available specimen.

Another platform function provided by the present system is a medium to view and/or purchase the available specimen. A user may view and/or purchase at least one of an initial specimen, a modified specimen, or a further modified specimen through the platform. Thus, a user may view the available specimen and choose to purchase a particular specimen that the user enjoys. In one embodiment, users must purchase the ability to view the available specimen. In another embodiment, a user may be granted the ability to view at least some of the available specimens but may be required to purchase access to the remaining available specimen. A user may also be required to purchase the ability to view some or all of the text and/or illustrations of a collection. In yet another embodiment, a user may have access to view the collections or available specimen but must purchase the ability to modify the available specimen.

By purchasing an available specimen, a user may be granted the right to remove the available specimen from the platform, allowing the user to use the available specimen however they choose. A purchase may be initiated through the platform by a user inputting payment information (e.g., credit or debit card information) into the platform. The platform may provide an interface in which a user may select which available specimen or collection material to purchase and input the user's payment information. In one embodiment, an electronic or physical copy of the purchased specimen may be provided to the user. In another embodiment, an available specimen is purchased and printed as a book.

In another embodiment of the present system, the platform may provide a means to rank any of the available specimens or collection material. A user may assign a personal ranking based on their own personal opinions. The platform may then accumulate all personal rankings for any available specimens or collection material and assign an overall ranking. Such an overall ranking may be visible to some or all users of the system. The overall rankings may be stored within a searchable database that is accessible to users. This function allows users to select available specimens that have proven popular to other users. Additionally, the platform may allow the ranking of the users. This user ranking may be derived from the rankings of available specimens created by said user.

The present invention also includes a method for creating a story utilizing the platform of the present system that is accessible to multiple users. The method may include at least one of, some of, or all of the following steps: (i) inputting a collection of text, illustrations, or a combination thereof into the platform; (ii) storing the collection; (iii) producing an initial specimen of select text and/or select illustrations picked from the collection; (iv) modifying the initial specimen to create a modified specimen; (v) further modifying the modified specimen to create a further modified specimen; (vi) viewing and/or purchasing at least a part of a collection or an available specimen; (vii) ranking one or more of a collection or an available specimen. In one embodiment, a single user performs one of, some of, or all of the method steps. In another embodiment, multiple users perform different method steps.

### Applications

The present invention includes numerous applications. One application is the use of the inventive system/method to collaboratively create a story or narrative. Collaborative story creation may be of particular benefit to children, who may need additional guidance or prompting to form completed stories. The present system allows multiple children (i.e., users) to contribute to a single story. For example, a first child may produce an initial specimen containing a single illustration of a butterfly. The first child may then modify the initial specimen by adding text that would be considered the beginning of a story about the butterfly, creating a modified specimen. A second child may then view the first child's modified specimen and further modify the modified specimen by adding text the completes the story, creating a further modified specimen. The further modified specimen may then also be available to other children for viewing or additional modification.

Furthermore, the system may provide an initial specimen that serves as a starting point for a user, which may be particularly useful for children. In one embodiment, the initial specimen includes a select illustration. A user may modify the initial specimen by inputting text that may or may not relate to the select illustration. Such a case may be referred to as WriteStories mode of the system. In WriteStories mode, the initial specimen may be completely void of any text. In another embodiment, the initial specimen incudes a select text. A user may modify the initial specimen by adding an illustration that may or may not relate to the select text. Such a case may be referred to as DrawStories mode. In DrawStories mode, the initial specimen may be completely void of any illustration.

In WriteStories mode and DrawStories mode, the initial specimen gives the user a jumping-off point. A user may write a story by inputting related text based off an initial select illustration in WriteStories mode. Similarly, a user may draw a story by inputting an illustration based off an initial select text. Additionally, the modified specimen created from WriteStories mode or DrawStories mode may be viewed and further modified by other users.

In another application, a user may modify an already published work. An initial specimen may contain at least part of a previously published work. The platform may provide a medium for a user to modify the previously published work by adding text and/or illustrations. In this application, users may add to or change already existing stories.

The system may also be utilized by publishers. Publishers may input one or more collections of material into the platform. Additionally, publishers may utilize the platform's ranking system to determine what highly ranked available specimen may be worth commercializing. Furthermore, marketing through the system may be accomplished by inputting only part of a completed work into the platform, exposing users to a work but forcing users to purchase the work from the publisher if the user wants access to the entire work.

Another application for the present system is using the system in an educational environment. An initial specimen may contain educational questions or prompts. A user may modify the initial specimen by adding an answer and/or prompt to the initial specimen, creating a modified specimen. An educator may then view the modified specimen to review and grade the user's submission. The educator may further modify the modified specimen by commenting on the user's answer/submission. The educator's further modification may then be viewed by the initial user.

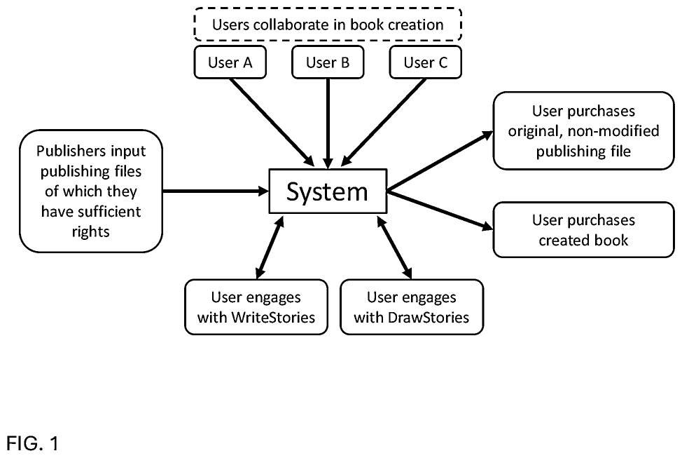

FIG. 1 depicts an embodiment of the present invention in which the platform is contained within a system in which publishers or other entities with rights to illustrated works input files of the works into the system. The files may be inputted into the system as combinations of text and illustrations. The text and illustrations may be uploaded independently or, after being uploaded, the text and illustrations may be segregated. This may be accomplished using optical scanning and character recognition, or in any other manner. Various users, such as users A, B and C may be able to access the inputted works. In an embodiment in which the users A, B and/or C wish to engage with the system in the WriteStories mode, the users have access to the illustrations of a selected inputted work and write text of their own creation to accompany the illustrations. In an embodiment in which the users A, B and/or C wish to engage with the system in the DrawStories mode, the users have access to the text of a selected inputted work and make illustrations of their own creation to accompany the text. In either mode, upon completion, the modified work may be purchased either as a physical book or as an electronic publishing file.

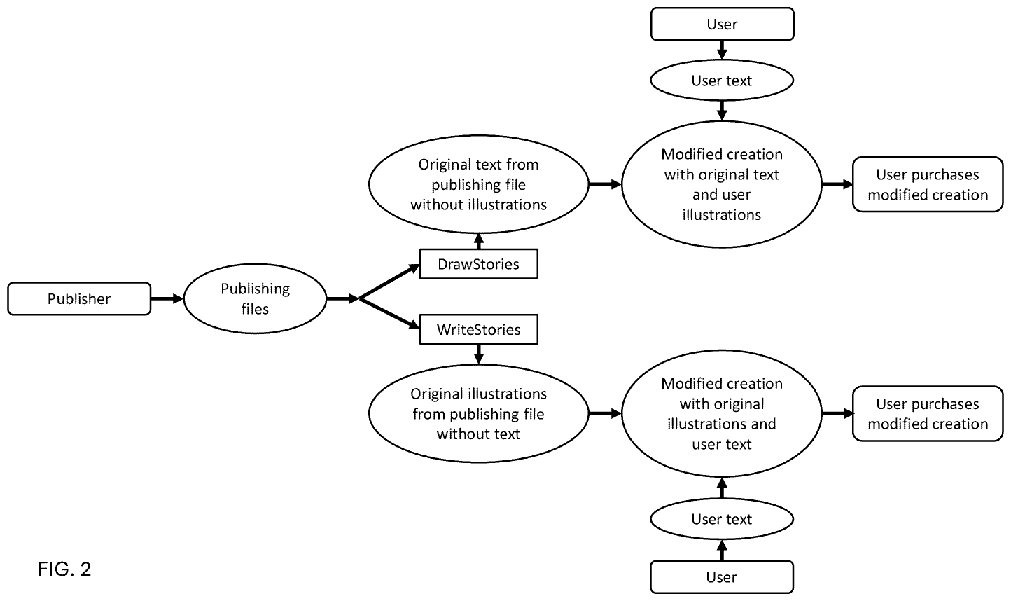

In the embodiment depicted in FIG. 2, again publishers or other entities with rights to illustrated works input files of the works into the system. The files may be inputted into the system as combinations of text and illustrations, which are preferably able to be segregated. A user then may engage with the system in the WriteStories mode, in which the user has access to the illustrations of a selected inputted work and writes text of their own creation to accompany the illustrations. A user may alternatively engage with the system in the DrawStories mode, in which the user has access to the text of a selected inputted work and makes illustrations of their own creation to accompany the text. In either mode, upon completion, the modified work may be purchased either as a physical book or as an electronic publishing file.

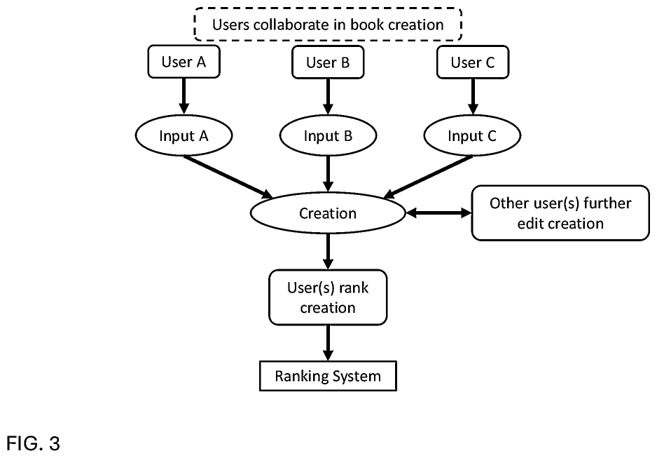

In the embodiment depicted in FIG. 3, again publishers or other entities with rights to illustrated works have inputted files of the works into the system. One or more of users A, B and/or C then may engage with the system in either the WriteStories mode or in the DrawStories mode to generate a modified work, shown in FIG. 3 as a creation. Additional users may be able to access the creation to further modify it. When a creation is generated, users may be able to access the creations from users A, B and/or C, and the further modifications made by others, and rank the generated creations using a ranking system.

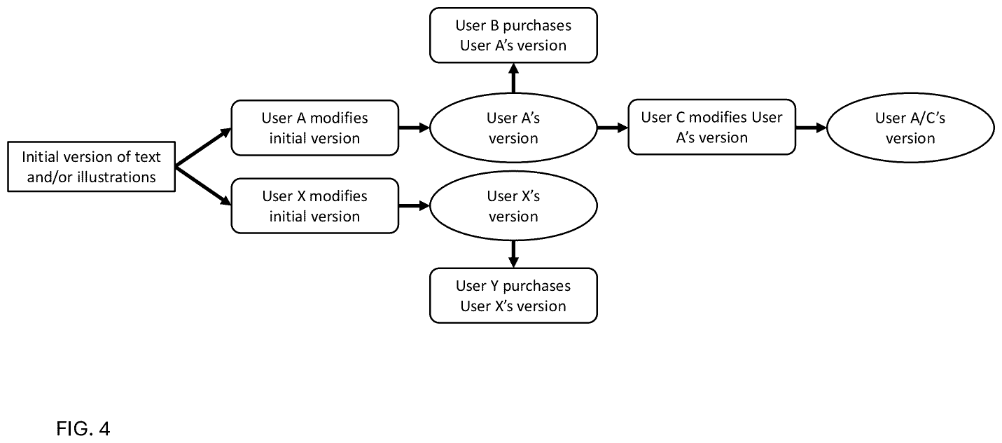

In the embodiment illustrated in FIG. 4, again publishers or other entities with rights to illustrated works have inputted files of the works into the system. Using either the DrawStories mode or the WriteStories mode, different users, such as user A and user X, modify the initial version. Either of those versions may be purchased, such as by user B or user Y. Either of those versions may also be further modified by another user, such as user C, to create a further modified version, such as shown as A/C's version. As before, upon completion the modified work may be purchased either as a physical book or as an electronic publishing file.

The following are examples of applications in which the method and system of the present invention may be employed. It should be understood that these examples are illustrative only, and other applications or uses are contemplated as being within the scope of the present invention.

In one example, the system of the present invention may be employed to enhance learning in subjects such as science, history, etc. by taking textbooks and removing key text. For example, the name of a gem or rock, or its properties, may be removed and a student may be required to fill in the missing information. This can be used in a learning context or as a way to test learning.

In another example, the system and method of the present invention may be opened to several language fonts to promote foreign language learning through story writing in other languages.

In another example, the system and method of the present invention may be employed to create a book using artificial intelligence (AI) to create illustrations, and then AI may be employed to adjust art styles to systematically teach the same.

In another example, the system and method of the present invention may be employed to provide a series of illustrations that a student can use to write a story, and then AI can be employed to generate a new series of illustrations to their story, and then a second person can write a story to those illustrations, etc. After several iterations, the stories can be compared in a gamification approach in a classroom setting.

In another example, AI may be employed in the system and method of the present invention, for example to analyze a person's level of writing and, if improving or declining, reporting the same to a teacher. AI may also be employed in writing a story, such as to suggest additional description, words, etc.

In another example, the system and method of the present invention may be employed to create a story, either written or AI generated, with pictures, either AI or illustrator created, and the story may have slots that early writers can fill in with words. This application would be suitable for children too young to write sentences but able to pick up on context.

In another example, AI may be used in the system and method of the present invention may be employed to make videos or animations out of WriteStories or DrawStories completed books, which may be adapted to provide virtual reality experiences.

In another example, the system and method of the present invention may be employed to custom create a library of books using AI, which are specifically generated so as be interacted with through Write or DrawStories so as to reflect a curriculum.

In another example, AI may be employed with the system and method of the present invention may be to provide feedback and grading for homeschooling parents. The system may anonymize learning from children of similar age, level of skill, interests, but use the learning to propose improvements to other parents

In another example, the system and method of the present invention may be used to provide a student/Child pairing system to co-write, i.e. to automatically detect students who have similar interests and level to allow them to co-write.

In another example, the system and method of the present invention may be employed to import past works to propose a curriculum for a full course of creative writing.

In another example, AI may be used in the system and method of the present invention may be to obtain an automatic baseline assessment for children or students, for example to ask questions or upload previous work in order to recognize patterns.

In another example, the system and method of the present invention may be employed to provide Automatic assignments based on the child's individual progress and evolution over time. For example the system may ask some questions upfront, or an algorithm may be employed, to detect when the story is not difficult enough and provide an adapted experience.

In another example, the system and method of the present invention may be employed to provide a unique program for teachers, such as a learning program unique to each child or class.

In another example, the system and method of the present invention may be employed to clarify characters to improve creative writing. For example, a child may create a general outline for a story and a gamification chatbot may help them clarify characters and improve creative writing skills (including the appearance, backstory, personality, and/or characters. which are important in creative writing.

In another example, the system and method of the present invention may be employed in an application in which social groups may filter books available to subscribers to a social circle that fits with the group's philosophical outlook, religious views, political views, etc.

In another example, the system and method of the present invention may be employed in a competition setting, in which the most “successful” book on a theme can be determined.

In another example, the system and method of the present invention may be employed in a commercial setting, in which a company can sponsor efforts to create works in line with their brand.

In another application, a book may be created using artificial intelligence based on user inputs. In this application, a work to be modified may be inputted into the system without the need to have obtained reproduction rights from any rights holders. In an application such as this, a story may be human created with images then being AI generated from the human-created story. The human-created story may then be removed for use in WriteStories mode. Similarly, AI may be used to create a story from human-created images, and the human-created images may be then be removed for use in DrawStories mode.

In another application, the system of the present invention may be used in language learning. In this application, the WriteStories mode may be employed to write a story based on illustrations, in which the story is written in the language being learned. This concept can be expanded to not just learn language but to learn about culture, for example by linking a learning classroom in one country, for example in the United States, with a learning classroom in another country, for example in Spain. By exchanging work between the geographically different countries, students can better understand what is written based on prompts provided by the illustrations to not only help in language learning but to also see different cultural perspectives and to learn dialect nuances, idioms, etc.

In another example, a student may create a story from illustrations using the WriteStories mode, and the system server could generate a separate set of images from the created story. The second set of images could then be provided to another user, such as a classmate, who writes a story to the second set of images in the WriteStories mode. After a number of rounds are completed, the original images and story are compared to the latest version.

The present invention may be used in a variety of other applications. In an example, the invention may be employed in a charitable fundraising application. In this application, a certain charitable organization is selected and a competition is created. Users can then either write stories to illustrations or create illustrations from stories. As part of the competition, each user solicits sponsors for his or her participation. The completed work of each user can then be sold to their sponsors, with the sales proceeds going to the charitable organization. In an alternative arrangement, the completed works are made available for viewing. The completed works can then be judged by those participating in a fundraising event, with votes translating to monetary donations to the charitable organization.

Although the best modes contemplated by the inventors of carrying out the present invention are disclosed above, practice of the present invention is not limited thereto. It will be manifest that various additions, modifications and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments.

We claim:

1. A system for story creation comprising:
a collection comprising text, illustrations, or a combination thereof;
a platform that is accessible to more than one user and provides a medium to
(i) input the collection into the platform, wherein a first user inputs the collection,
(ii) store the collection, and
(iii) enable a second user to produce a specimen comprising a select text, a select illustration, or a combination thereof, wherein the selected text is selected from the text of the collection and the selected illustration is selected from the illustrations of the collection.

2. The system of claim 1, wherein the platform provides a medium to modify the specimen to create a modified specimen.

3. The system of claim 2, wherein a third user modifies the specimen.

4. The system of claim 2, wherein the platform provides a medium to purchase the modified specimen.

5. The system of claim 2, wherein the specimen consists of only one of the specimen text or the specimen illustration, and the modified specimen comprises both the specimen text and the specimen illustration.

6. The system of claim 1, wherein the platform is capable of distinguishing between inputted text and inputted illustrations, and the platform removes one of the text or the illustration.

7. The system of claim 1, wherein the platform provides a medium for the more than one third users to collaborate to produce a modified specimen.

8. A method for creating a story comprising:
providing a platform that is accessible to more than one user;
inputting a collection into the platform by a first user, wherein the collection comprises text, illustrations, or a combination thereof;
storing the collection within the platform; and
producing an initial specimen comprising a specimen text, a specimen illustration, or a combination thereof, wherein the specimen text is selected from the collected text of the collection and the specimen illustration is selected from the collected illustrations of the collection.

9. The method of claim 8, further comprising modifying the initial specimen, thereby creating a modified specimen.

10. The method of claim 9, wherein the initial specimen is modified by a second user.

11. The method of claim 9, further comprising purchasing the modified specimen through the platform.

12. The method of claim 9, wherein the modified specimen comprises both the specimen text and the specimen illustration, wherein the initial specimen consists of only one of the specimen text and the specimen illustration.

13. The method of claim 9, further comprising modifying the modified specimen by a third user; and
creating a further modified specimen.

14. The method of claim 8, further comprising distinguishing between the specimen text and the specimen illustration in the initial specimen; and
removing one of the specimen text and the specimen illustration from the initial specimen.

15. The method of claim 8, further comprising collaborating between more than one user.

16. A system for collaborative story creation comprising:
a collection comprising collected text, collected illustrations, or a combination thereof;
a platform comprising
a collection database that stores the collection;
an initial specimen, the initial specimen comprising a specimen text, a specimen illustration, or a combination thereof, wherein the specimen text is selected from the collected text of the collection and the specimen illustration is selected from the collected illustration; and
a modifying medium for more than one user to modify the initial specimen to create a modified specimen.

17. The system of claim 16, further comprising a purchasing medium for the more than one user to purchase the modified specimen.

18. The system of claim 16, further comprising a further modifying medium for the more than one user to further modify the modified specimen to create a further modified specimen.

19. The system of claim 16, wherein at least two of the more than one users modifies the initial specimen to create a modified specimen.
